(19) United States
(12) Patent Application Publication
(10) Pub. No.: US 2013/0031107 A1
(43) Pub. Date: Jan. 31, 2013

(54) PERSONALIZED RANKING METHOD OF VIDEO AND AUDIO DATA ON INTERNET

(71) Applicants: Jen-Yi PAN, Chiayi County (TW); Oscal Tzyh-Chiang Chen, Chiayi County (TW); Wen-Nung Lie, Chiayi County (TW)

(72) Inventors: Jen-Yi PAN, Chiayi County (TW); Oscal Tzyh-Chiang Chen, Chiayi County (TW); Wen-Nung Lie, Chiayi County (TW)

(21) Appl. No.: 13/435,647

(22) Filed: Mar. 30, 2012

(30) Foreign Application Priority Data
Jul. 29, 2011 (TW) 100127105

(51) Int. Cl. G06F 17/30

(52) U.S. Cl. 707/749; 707/E17.009

(57) ABSTRACT

A personalized ranking method of audio and/or video data on Internet includes the steps of locating a plurality of audio and/or video data corresponding to at least one keyword; deciding a user index by the user or picking a history behavior index if the user does not decide the user index; capturing characteristics from the aforesaid downloaded audio and/or video data according to the user index or the history behavior; comparing the captured characteristics with a user profile or a history behavior for similarity to get a similarity score; ranking the audio and/or video data according to the corresponding similarity scores to get a ranking outcome of the audio and/or video data.

### BACKGROUND OF THE INVENTION

1. Field of the Invention

The present invention relates generally to a personalized arrangement method of data, and more particularly, to a personalized ranking method of audio and video data on Internet.

2. Description of the Related Art

US Patent No. 2010/0138413A1 disclosed a system and method for personalized search, which include a search engine that receives an input from a user, processes a user identification and generates a search result based on the input; and a profiling engine to gather profile data, generate a user profile associated with a user, and rank the search result personalized to the specific user using the user profile.

European Patent No. 1647903A1 disclosed systems and methods that employ user models to personalize queries and/or search results according to information that is relevant to respective user characteristics. The user model may be assembled automatically via an analysis of a user's behavior and other features, such as the user's past events, previous search history, and interactions with the system. Additionally, the user's address or e-mail address can come up with the city where the user is located. For example, when the user looks for “weather,” the information about the weather in the city where the user is located can be automatically found.

Taiwan Patent No. 579478 disclosed that the users' Internet behaviors were recorded and statistically processed via a variety of Internet services where the users' frequencies of utilization, semantic correlation, and satisfaction with the services were compared and analyzed, and then the result of the analyses were employed to recommend which Internet services were applicable for the users.

U.S. Pat. No. 7,620,964 disclosed a recommended television (TV) or broadcast program search device and method, which record the user's viewing programs and viewing time to recommend the user's favorite programs and channels. In this patent, the recommendation refers to the program types and viewing time, and the viewing history information will be erased while a period of time passes.

Taiwan Patent No. 446933 disclosed a device capable of analyzing voice for identifying emotion and this device could be applied to multimedia applications, especially in lie detection.

However, none of the above devices or methods is directed to searching video and audio data on Internet and arranging or ranking the data according to the user's personal preference after they are downloaded.

### SUMMARY OF THE INVENTION

The primary objective of the present invention is to provide a personalized ranking method, which can rank the audio and video data located in and downloaded from Internet according to the user's preference to meet the user requirement.

The foregoing objective of the present invention is attained by the personalized ranking method having the steps of a) locating and downloading video and audio data corresponding to at least one key word selected by the user on Internet; b) getting a user index from the user's input or picking a history behavior index if the user does not input the user index where the user index and the history behavior index indicate one of the user activity preference, audio emotion type, and video content type or a combination thereof; c) capturing one of or more characteristics from the aforesaid downloaded audio and/or video data according to the user index or the history behavior index; d) comparing the captured characteristics with a user profile or a history behavior for similarity to attain a similarity score corresponding to each audio and/or video datum where the similarity score is one of the user activity preference, audio emotion type, and video content type or a combination thereof; and e) ranking the audio and/or video data according to the corresponding similarity scores to accomplish a ranking outcome of the audio and/or video data.

### BRIEF DESCRIPTION OF THE DRAWINGS

FIG. 1 is a flow chart of a first preferred embodiment of the present invention.

FIG. 2 is a schematic view of the first preferred embodiment of the present invention, illustrating the distribution of various emotions.

FIG. 3 is a flow chart of the first preferred embodiment of the present invention, illustrating the processing of the audio data.

FIG. 4 is a flow chart of the first preferred embodiment of the present invention, illustrating the processing of the video data.

FIG. 5 is a flow chart of the first preferred embodiment of the present invention, illustrating the processing of comparison for similarity.

### DETAILED DESCRIPTION OF PREFERRED EMBODIMENTS

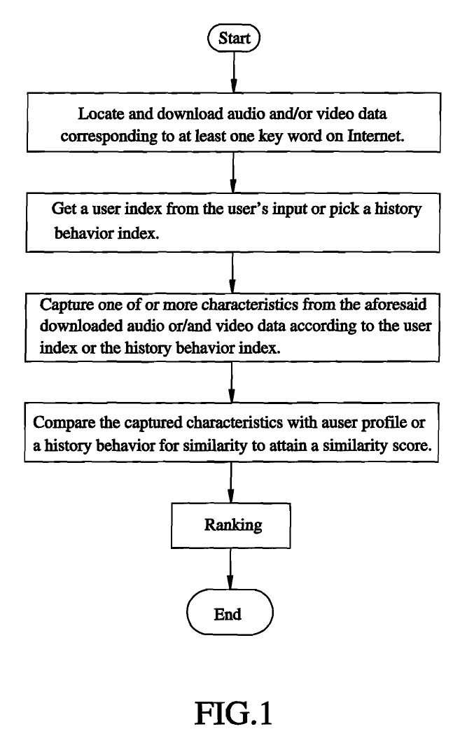

Referring to FIG. 1, a personalized ranking method of audio and/or video data on Internet in accordance with a first preferred embodiment includes the following steps.

a) Enter at least one keyword selected by the user via an Internet-accessible device to locate corresponding audio and/or video data on specific websites through Internet and then download the corresponding audio and/or video data into the Internet-accessible device. The Internet-accessible device can be but not limited to a computer, a smart phone, and an Internet television (TV); in this embodiment, it is a computer as an example. Besides, each audio and video datum has a metadata, including category, tags, keywords, duration, rating, favorite count, view count, publishing date and so on.

b) Obtain a user index from the user's input or pick a history behavior index if the user does not decide the user index. Each of the user index and the history behavior index indicates one of the user activity preference, audio emotion type and video content type or a combination thereof.

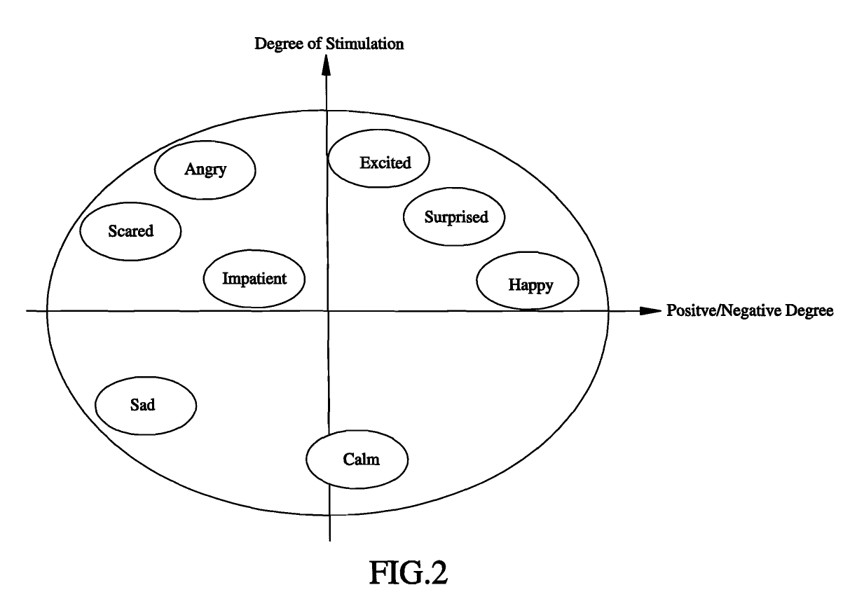

c) Capture one of characteristics from the aforesaid downloaded audio and/or video data subject to the user index or the history behavior index via a computing device. If the user index is the user activity preference, the captured characteristic is a metadata tag of each audio and/or video datum. The user activity preference contains the history of keywords, frequency and time that the user has listened to and/or watched this kind of audio and/or video. If the user index is the audio emotion type, the captured characteristic is an emotion type corresponding to the audio part of each audio and video datum. If the user index is the video content characteristics corresponding to the type, the captured characteristics are the movement and brightness of video part of each audio and video data. Please refer to FIG. 2 for audio emotion classification. The computing device can be a computer, a smart phone or an Internet TV. In this embodiment, the computer device is, but not limited to, a computer. The aforesaid history behavior index indicates the user's browsing record.

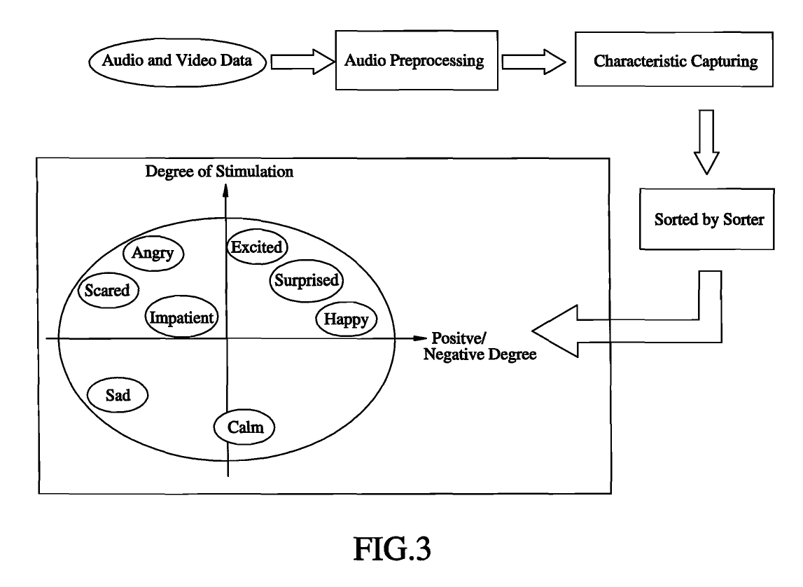

In this step, the audio characteristic capturing and the audio emotion-type identification include sub-steps of audio preprocessing, characteristic capturing and sorter classification, referring to FIG. 3. The audio preprocessing includes sampling, noise removal and audio frame cutting. Here, employing signal processing to reinforce the signals, which are intended to be captured, is to prevent the outcome of the identification from bad audio quality and to avoid inaccuracy. Characteristic capturing must be based on different affective modes of audio data. For example, the audio data characterized in happiness or happiness-prone emotions correspond to brisk background music and dialogue; the audio data characterized in sorrow or negative emotions correspond to slow or disharmonic background music and dialogue. The sorter classification can be realized by three manners—one-level classification structure, multi-level classification structure, and adaptive learning structure. The one-level classification method is to create a variety of models based on all kinds of classification types and then generate all of audio characteristics of audio and/or video data in the format of vectors for classification in a one-level structure. The difficulty of this method lies in that it is necessary to create multiple models in which numerous accurately classified characteristic parameters are required to ensure the accuracy to a certain degree. The multiple-level classification method is to classify the audio data of audio and/or video data one after another level according to the specific classification criteria of each level. However, the classification error resulting from the front-end level is propagated to the rear-end level to yield the classification inaccuracy, so it is the current important object to add an adaptive learning mechanism into the sorter. Because audio data in the database for training are limited, even if the classification method is rather effective, it is still not easy to contain all situations. If the heuristic rule based on the user's tests can be incorporated into the learning mechanism, endless adaptive learning during various practically-used scenarios can effectively enhance a recognition rate.

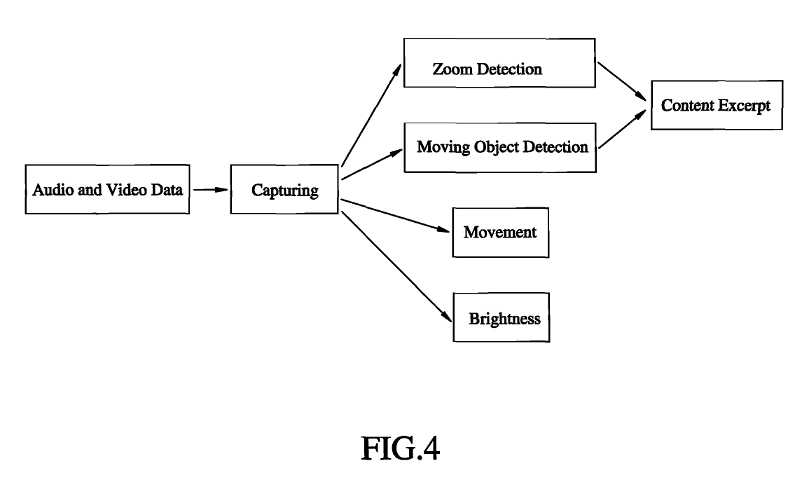

Besides, referring to FIG. 4, in the process of capturing the characteristic of video part of each audio and video datum in the step c), the corresponding movement and brightness can be acquired and the content excerpt also can be made from each audio and video datum. Content excerpting is based on zoom detection and moving object detection. Such a short clip (e.g. 1-2 minutes) made from content excerpting allows the user directly to watch it and understand its general idea efficiently in a short period. However, such content excerpt will not be used for comparison or other purpose later.

For example, in the process of capturing the characteristic from the movement and brightness corresponding to the video part of audio and video data, the movement and brightness are categorized into four classes “swift/bright”, “swift/dark”, “slow/bright”, and “slow/dark” and scored 0-100. The swift/bright class indicates highly moving and bright video data and the slow/dark class indicates lowly moving and dark video data. According to such classification, the movement and bright degrees of each audio and video datum can be acquired.

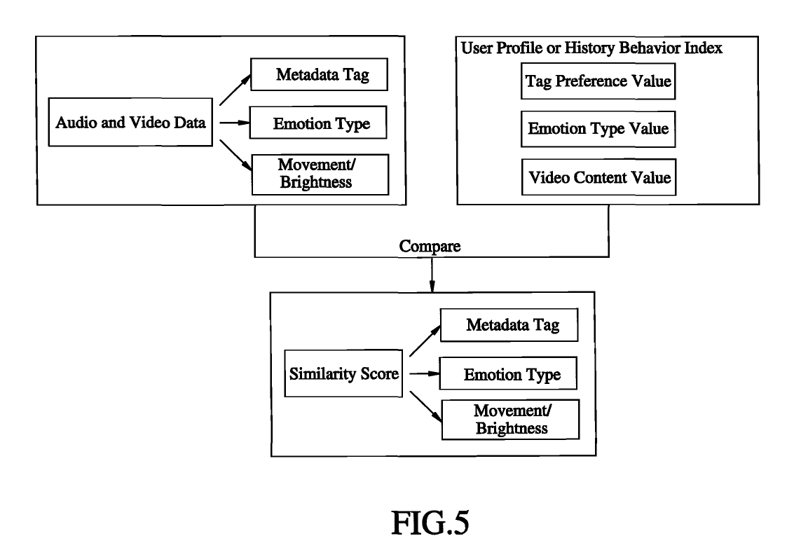

d) Compare the captured characteristics of each audio and/or video datum with a user profile or a history behavior for similarity, as shown in FIG. 5. The user profile includes a tag preference value corresponding to the metadata tag indicated in the step c), an emotion type value corresponding to the audio emotion type indicated in the step c), and a video content value corresponding to the movement and brightness of the video part indicated in the step c). After the similarity comparison, a similarity score corresponding to each audio and video datum can be acquired. The similarity score corresponds to the aforesaid metadata tag, audio emotion type, movement and brightness of the video part, or a combination thereof.

The aforesaid similarity analysis can employ a cosine similarity method to figure out an audio emotion score SIMₑₘₒₜᵢₒₙ in a film via the audio emotion type identification of the audio part and the emotion type value in the user index indicated in the step b). The formula is presented as follows:

$${Sim}_{emotion} ( S , E ) = \frac{S \cdot E}{‖ S ‖ \cdot ‖ E ‖} = \frac{{\sum }_{i} {s}_{i} \cdot {e}_{i}}{\sqrt{{\sum }_{i} {s}_{i}^{2} \cdot {\sum }_{i} {e}_{i}^{2}}} \qquad ( 1 )$$

where S=(s₁, . . . , s₈), which is a vector composed of initial scores of eight emotion categories; sᵢ is an emotion type value in the user index or the history behavior index. In the audio emotion analysis, audio and video data of a film can be analyzed to come up with the ratio of eight emotion types where the result of the analysis is presented by a vector E. E=(e₁, . . . , e₈) indicates the vector of coverage ratios of the following eight emotion types after the audio emotion is analyzed. eᵢ indicates the coverage ratio of the emotion i of the audio and video data of one film. An example is indicated in the following Table 1.

TABLE 1

| | | | | | | | | |
|---|---|---|---|---|---|---|---|---|
| Score | 5 | 6 | 7 | 8 | 7 | 6 | 5 | 4 |
| Vector (S) | | | | | | | | |
| Emotion | Excited | Happy | Surprised | Calm | Sad | Scared | Impatient | Angry |
| Type | | | | | | | | |
| Vector (E) | 10% | 30% | 10% | 20% | 10% | 5% | 10% | 5% |

If the emotion type value in the user index or the history behavior index is set “calm”, it (s₄) will score 8 (the highest score) and the similar emotion types, like “surprised” and “sad”, will score 7 (the second highest score) each. The other emotion types follow the same rule, so the initial score vector of eight emotion types is presented by S=(5, 6, 7, 8, 7, 6, 5, 4). Another example is indicated in the following Table 2.

TABLE 2

| | | | | | | | | |
|---|---|---|---|---|---|---|---|---|
| Score | 8 | 7 | 6 | 5 | 4 | 3 | 2 | 1 |
| Vector (S) | | | | | | | | |
| Emotion | Excited | Happy | Surprised | Calm | Sad | Scared | Impatient | Angry |
| Type | | | | | | | | |
| Vector (E) | 10% | 30% | 10% | 20% | 10% | 5% | 10% | 5% |

If the emotion type value in the user profile is set “excited”, it (s₁) will score 8 (the highest score) and the adjacent emotion type “happy” will score 7 (the second highest score). The other emotion types follow the same rule, so the initial score vector of eight emotion types is presented by S=(8, 7, 6, 5, 4, 3, 2, 1). The audio part of audio and video data of a film is then processed by the audio emotion analysis to come up with the vector (E). Provided that the audio part is analyzed, the ratios of the eight emotions are 10%, 30%, 10%, 20%, 10%, 5%, 10%, and 5% separately, so the vector of the ratios of the audio emotion can be inferred as E=(0.1, 0.3, 0.1, 0.2, 0.1, 0.05, 0.1, 0.05) and finally an audio emotion score of audio and video data can be figured out via the aforesaid formula.

e) Rank the audio and video data according to the corresponding similarity scores separately via a computing device to get a ranking outcome of the audio and video data. The ranking can be based on either one of the three kinds of similarity scores (i.e. tags, audio, and video) indicated in the step d) or multiple similarity scores. When the ranking is based on the multiple similarity scores, weight allocation can be applied to any one or multiple of the three kinds of similarity scores according to an operator's configuration.

As indicated above, in the first embodiment, the present invention includes the steps of downloading a plurality of audio and video data after at least one keyword is defined by the user on Internet, capturing the characteristic from each of the aforesaid downloaded audio and/or video data to obtain the information such as metadata tags, emotion types, and brightness and movement of each audio and video datum, further comparing the aforesaid information with the user profile via the Internet-accessible device (e.g. computer) to get the similarity scores based on the user's preference, and finally ranking the audio and video data according to the user's preference to get the sorting of the audio and video data according to the user's preference.

In this embodiment, keywords, metadata tags, emotion types, and movement and brightness are acted as conditions for comparison to get a ranking outcome; however, if the movement and brightness are not taken into account and only the audio emotion type and the tag are used for comparison and ranking, an outcome in conformity with the user's preference can also be concluded. The comparison based on the movement and brightness in addition to the other aforesaid conditions can come up with more accurate outcome for audio and video data. In other words, the present invention is not limited to the addition of the movement and brightness of the video part.

In addition, in this embodiment, only the metadata tags, or the emotion types, or the movement and brightness are used in coordination with keywords as the conditions for comparison to come up with a ranking outcome, which can also conform to the user's preference. Although such outcome is worse than what all of the three conditions are used for comparison, it is still based on the user's preference.

A personalized ranking method of audio and/or video data on Internet in accordance with a second preferred embodiment is similar to that of the first embodiment, having the difference recited below.

A sub-step d1) is included between the steps d) and e) and weight ranking method or hierarchy ranking method can be applied to this sub-step d1).

When the weight ranking method is applied, the similarity scores corresponding to the tag, the audio emotion type, and/or the movement and brightness of the video part can be processed by a combination operation to get a synthetic value. In the step e), all of the audio and/or video data can be ranked subject to the synthetic values instead of the corresponding similarity scores.

When the weight ranking method is applied, for example, provided K films are intended to be ranked, the film A is ranked A1 in the sequence based on the metadata tags combined with the emotion type, its video movement and brightness are ranked A2, and the weight values of such two ranking methods are R1 and R2 separately, so the final ranking of the film A is Ta=A1×R1+A2×R2 and the final ranking values for K films will be Ta, Tb . . . Tk. As the final ranking value of the film is less, that film will be firstly recommended.

An example is indicated in the following Table 3. Three currently available films A, B & C are listed for the ranking. The rankings based on the metadata tags in combination with the emotion types for the three films A-C are 1, 2, and 3 separately. The rankings based on the movement and brightness for the three films A-C are 2, 1, and 3 separately. What each of the rankings based on the metadata tags in combination with the emotion types times a weight 0.7 and what each of the rankings based on the movement and brightness times a weight 0.3. Then, adding these two yields a final value. The film with a smaller value is ranked prior to that with a larger value, so the final rankings for the three films are still 1, 2 & 3. The weighted rankings for multiple films can follow such a concept to get final rankings.

TABLE 3

| | Film A | Film B | Film C |
|---|---|---|---|
| Ranking based on tag | 1 | 2 | 3 |
| in combination with | | | |
| emotion type (×0.7) | | | |
| Rankings based on the | 2 | 1 | 3 |
| movement and | | | |
| brightness (×0.3) | | | |
| Integrated | 1 × 0.7 + 2 × | 2 × 0.7 + 1 × | 3 × 0.7 + 3 × |
| calculational process | 0.3 = 1.3 | 0.3 = 1.7 | 0.3 = 3 |
| Final ranking | 1 | 2 | 3 |

When the hierarchy ranking method is applied, the user index is categorized into three levels—(1) emotion type of audio part, (2) metadata tag, and (3) movement and brightness of video part, and then the recommended films are ranked based on such levels of the user index. Provided K films are listed for ranking, in the first level of emotion type, the K films will be classified into two groups “conformable to what the user selects or previously used emotion” and “not conformable to what the user selects or previously used emotion”. The group “conformable to what the user selects or previously used emotion” needs to be ranked in front of the other group “not conformable to what the user selects or previously used emotion”. In the second level of tag classification, the films are ranked subject to how high/low the scores of the tags are; the films with high scores are ranked high. In the process of the second-level classification, when the tags score the same, proceed to the third-level comparison. In the third-level classification of the movement and brightness of the video part, apply one more ranking to the films with the tags of the same score according to the user's preference for the movement and brightness of the video part. If the scores of the movement and brightness of the video part conform to the user's preference, the films will be prioritized.

In conclusion, the present invention can rank the audio and/or video data located in and downloaded from Internet according to the user's preference to meet the user requirement.

Although the present invention has been described with respect to two specific preferred embodiments thereof, it is in no way limited to the specifics of the illustrated structures but changes and modifications may be made within the scope of the appended claims.

What is claimed is:

1. A personalized ranking method of audio and/or video data on Internet, comprising steps:
a) locating and downloading audio and/or video data corresponding to at least one keyword selected by the user on Internet;
b) getting a user index from the user's input or picking a history behavior index if the user does not decide the user index where each of the user index and the history behavior index indicates one of the user activity preference, audio emotion type, and video content type or a combination thereof;
c) capturing one or more of characteristics from the aforesaid downloaded audio and/or video data according to the user index or the history behavior index;
d) comparing the captured characteristics with a user profile or a history behavior for similarity to attain a similarity score corresponding to each audio and/or video datum where the similarity score is one of the user activity preference, audio emotion type, and video content type or a combination thereof; and
e) ranking the audio and/or video data according to the corresponding similarity scores to get a ranking outcome of the audio and/or video data.

2. The personalized ranking method as defined in claim 1, wherein in the step a), the Internet is accessed by a Internet-accessible device, which can be a computer, a smart phone, or an Internet television.

3. The personalized ranking method as defined in claim 1, wherein in the step c), if the user index is the user activity preference, the captured characteristic is a metadata tag of each audio and/or video datum, the metadata tag containing the history of keywords, frequency and time that the user has listened to and/or watched this kind of audio and/or video; if the user index is the audio emotion type, the captured characteristic is an emotion type corresponding to the audio part of each audio and video datum; if the user index is the video content type, the captured characteristic is the movement and brightness corresponding to the video part of each video datum; the history behavior is the user's records; in the step d), each of the user's profile and the history behavior has a tag preference value corresponding to the aforesaid metadata tag, an emotion type value corresponding to the aforesaid audio part, and a video type value corresponding to the movement and brightness of the aforesaid video part; the similarity scores can be got, after the similarity comparison, to correspond to the aforesaid metadata tag, the audio emotion type, the movement and brightness of the video part, or a combination thereof.

4. The personalized ranking method as defined in claim 1, wherein in the steps b), c), d), and e), a computing device is employed for computation, comparison, and ranking and can be a computer, a smart phone or an Internet TV.

5. The personalized ranking method as defined in claim 1, wherein in the step c), the characteristics of the audio and video data each indicate the corresponding audio emotion type or video content type.

6. The personalized ranking method as defined in claim 1, wherein in the step d), the similarity analysis can be based on a cosine similarity method.

7. The personalized ranking method as defined in claim 3 further comprising a sub-step d1), to which a weight ranking method is applied, wherein the similarity scores corresponding to the metadata tag, the audio emotion type, and/or the movement and brightness of the video part can be processed by a combination operation to get a synthetic value; in the step e), the ranking is based on the synthetic value.

8. The personalized ranking method as defined in claim 3, wherein further comprising a sub-step d1), to which a hierarchy ranking method is applied, wherein the ranking is based on the similarity score corresponding to the audio emotion type, then the similarity score corresponding to the metadata tag, and finally the similarity score corresponding to the movement and brightness of the video part.

9. The personalized ranking method as defined in claim 1, wherein in the step c), content excerpt can be further made from each video datum, the excerpted characteristics having zoom detection and moving object detection.

10. The personalized ranking method as defined in claim 1, wherein in the step a), the audio and video data are located on specific websites on Internet.
